(19) United States
(12) Patent Application Publication
(10) Pub. No.: US 2009/0233512 A1
(43) Pub. Date: Sep. 17, 2009

(54) Method For Producing Barrier Rib Substrate For Plasma Display Panel

(75) Inventor: Tatsutoshi Kanae, Miyazaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: FUJITSU HITACHI PLASMA DISPLAY LIMITED, Miyazaki (JP)

(21) Appl. No.: 12/090,365

(22) PCT Filed: Dec. 20, 2005
(86) PCT No.: PCT/JP2005/023387

§ 371 Date: Apr. 16, 2008

(51) Int. Cl. H01J 9/00

(52) U.S. Cl. 445/24

(57) ABSTRACT

The present invention provides a method by which a barrier rib substrate for a plasma display panel can be produced easily.

A method for producing a barrier rib substrate for a plasma display panel of the present invention includes the steps of: producing a barrier rib substrate for a large plasma display panel by forming electrodes extending in a predetermined direction on a substrate and barrier ribs on the substrate or in the substrate itself; and producing four or more barrier rib substrates for small plasma display panels with barrier ribs formed up to the substrate end by performing, in regard to the barrier rib substrate for the large plasma display panel, division in a direction orthogonal to a direction in which the electrodes extend and at least one-time division in a direction parallel to the direction in which the electrodes extend.

### TECHNICAL FIELD

The present invention relates to a method for producing a barrier rib substrate for a plasma display panel (hereinafter, referred to as PDP), a PDP and a method for producing the PDP.

### BACKGROUND ART

The PDP includes a pair of substrates opposed to each other, and on one of the substrates, electrodes (for example, address electrodes) extending in a predetermined direction and barrier ribs for separating a discharge space are formed (hereinafter, a substrate with barrier ribs thereon is referred to as a “barrier rib substrate”).

Here, a method for producing a conventional barrier rib substrate will be described.

FIG. 11(a) shows a barrier rib substrate for a large PDP and FIG. 11(b) shows a yet-to-be-divided barrier rib substrate for plural small PDPs. In the barrier rib substrate for a large PDP shown in FIG. 11(a), barrier ribs 53 having a pattern corresponding to that of one large PDP are formed on a substrate 51. In the yet-to-be-divided barrier rib substrate for plural small PDPs shown in FIG. 11(b), barrier ribs 53 having patterns corresponding to those of four small PDPs are formed on the substrate 51. The yet-to-be-divided barrier rib substrate for plural small PDPs in FIG. 11(b) is divided into four sections along dotted lines shown in the drawing and these four sections are used as four barrier rib substrates for small PDPs. A divided barrier rib substrate for a small PDP is shown in FIG. 11(c). In addition, the address electrodes are not shown for convenience of illustration, but the address electrodes are formed so as to extend in the same direction as that of the barrier ribs 53 between adjacent barrier ribs 53.

As described above, patterns of the barrier ribs 53 in the barrier rib substrate for a large PDP differs from those of the yet-to-be-divided barrier rib substrate for plural small PDPs. A photomask to be used in a photolithography step is changed in order to change the pattern of the barrier ribs 53.

### Patent Document 1: Japanese Patent Application Laid-Open (JP-A) No. 2005-25949

### DISCLOSURE OF THE INVENTION

### Problems to be Solved by the Invention

In the above conventional method, it is necessary to prepare a plurality of photomasks in producing a barrier rib substrate for a large PDP and a barrier rib substrate for small PDPs and to change the setup conditions of a production line in producing each barrier rib substrate. These all lead to an increase in the production cost of the barrier rib substrate.

The present invention has been achieved in view of the above-mentioned circumstances and provides a method by which a barrier rib substrate for a PDP can be produced easily.

A method for producing a barrier rib substrate for a PDP of the present invention comprises the steps of: producing a barrier rib substrate for a large PDP by forming electrodes extending in a predetermined direction on a substrate and barrier ribs on the substrate or in the substrate itself; and producing four or more barrier rib substrates for small PDPs with barrier ribs formed up to the substrate end by performing, in regard to the barrier rib substrate for the large PDP, division in a direction orthogonal to a direction in which the electrodes extend and at least one-time division in a direction parallel to the direction in which the electrodes extend.

In the method of the present invention, barrier rib substrates for small PDPs are produced by dividing a barrier rib substrate for a large PDP. Therefore, it is not necessary to prepare another photomask for producing the barrier rib substrate for small PDPs. Further, in a production line of the barrier rib substrate, it is possible to omit the effort to change the setup conditions of the production line since only one kind of barrier rib substrate needs to be produced. It should be noted that, in this specification, the term “small” does not indicate an absolute size and means that the size is smaller than that of “large”.

### BRIEF DESCRIPTION OF THE DRAWINGS

FIGS. 1(a) and 1(b) show a structure of a yet-to-be-divided barrier rib substrate for a large PDP according to a method for producing a barrier rib substrate for a PDP of a first embodiment of the present invention, and FIG. 1(a) is a plan view and FIG. 1(b) is a sectional view taken on a line I-I in FIG. 1(a).

FIG. 2 is a sectional view, corresponding to FIG. 1(b), of another embodiment different from the barrier rib substrate for a large PDP of FIG. 1.

FIG. 3 is a sectional view, corresponding to FIG. 1(b), of another embodiment different from the barrier rib substrate for a large PDP of FIG. 1.

FIG. 4 is a plan view, corresponding to FIG. 1(a), of another embodiment different from the barrier rib substrate for a large PDP of FIG. 1.

FIG. 5 is a plan view showing a structure of a barrier rib substrate for a small PDP after division according to a method for producing a barrier rib substrate for a PDP of the first embodiment of the present invention.

FIG. 6 is a plan view, corresponding to FIG. 1(a), of another embodiment different from the barrier rib substrate for a large PDP of FIG. 1.

FIG. 7 is a plan view showing a structure of a yet-to-be-divided barrier rib substrate for a large PDP according to a method for producing a barrier rib substrate for a PDP of another embodiment of the present invention.

FIG. 8 is a plan view showing a structure of a barrier rib substrate for a PDP produced by a method for producing a barrier rib substrate for a PDP of a second embodiment of the present invention.

FIG. 9 is a plan view, corresponding to FIG. 8, which shows a structure of a barrier rib substrate for a PDP produced by a method for producing a barrier rib substrate for a PDP of another embodiment of the present invention.

FIGS. 10(a) to (b) show a state, in which phosphor layers are formed on the barrier rib substrate for a small PDP of FIG. 5, and FIG. 10(a) is a plan view and FIG. 10(b) is a sectional view taken on a line I-I in FIG. 10(a).

FIGS. 11(a) to 11(c) are plan views according to a conventional method for producing a barrier rib substrate for a PDP, and FIG. 11(a) shows a barrier rib substrate for a large PDP, FIG. 11(b) shows a yet-to-be-divided barrier rib substrate for small PDPs, and FIG. 11(c) shows a barrier rib substrate for a small PDP after division.

### DESCRIPTION OF THE REFERENCE NUMERALS AND SYMBOLS

1: substrate 1a: side orthogonal to an address electrode 1b: side parallel to an address electrode 3: address electrodes 5: dielectric film 7: barrier ribs 9: neighboring region of substrate end 11: region between barrier ribs 13: exhaust hole 15a to 15d: barrier rib substrate units for a small PDP 17: phosphor layers 51: substrate 53: barrier ribs

### BEST MODE FOR CARRYING OUT THE INVENTION

Hereinafter, an embodiment of the present invention will be described with reference to drawings. The drawings are used for convenience sake of description and accordingly, the present invention is not to be considered as being limited by the embodiments shown in drawings. In the following embodiments, the present invention will be described by exemplifying the case where barrier ribs are formed on the substrate on which address electrodes are formed, but the present invention can also be applied to the case where barrier ribs are formed on the substrate on which other electrodes such as display electrodes are formed.

### 1. Method for Producing Barrier Rib Substrate for PDP

### 1-1. First Embodiment

A method for producing a barrier rib substrate for a PDP of a three-electrode surface-discharge PDP of the first embodiment of the present invention will be described.

### 1-1-1. Production Step of Barrier Rib Substrate for Large PDP

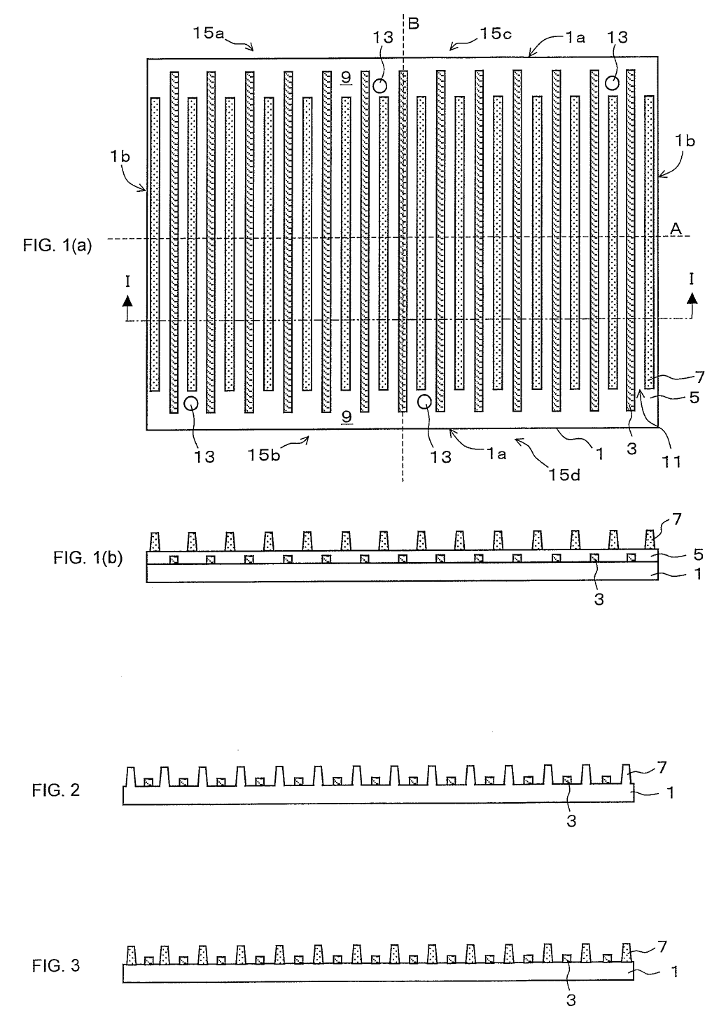

First, as shown in FIGS. 1(a) and 1(b), a barrier rib substrate for a large PDP is produced by forming address electrodes 3 extending in a predetermined direction on a substrate 1, a dielectric layer 5, and barrier ribs 7 in succession. FIG. 1(a) is a plan view and FIG. 1(b) is a sectional view taken on a line I-I in FIG. 1(a),

The barrier rib substrate for a large PDP of this embodiment can be used for producing one large PDP or can be used for producing four or more small PDPs by dividing the barrier rib substrate. Dotted lines A, B shown in FIG. 1(a) indicate the location where division is performed in a subsequent step. Reference symbols 15a to 15d indicate a unit (referred to as a “barrier rib substrate unit for a small PDP”) to become a barrier rib substrate for a small PDP after division. In each of units 15a to 15d, an exhaust hole 13 may be provided before division or may be provided after division. The exhaust hole 13 is used for vacuum evacuation and filling of discharge gas in the subsequent step.

As the substrate 1, a substrate of glass, quartz, ceramic, or the like, or a substrate on which desired constituents such as an electrode, an insulating film, a dielectric layer, a protective film, and the like, are formed can be employed.

The address electrodes 3 are composed of Ag, Au, Al, Cu, Cr, laminates thereof (for example, Cr/Cu/Cr laminate structure), or the like. Desired number of the address electrodes 3 with desired thickness, width, and spacing may be formed by employing a printing method for Ag and Au and combining a film formation method such as a vapor deposition method, a sputtering method or the like with an etching method for the other materials. Typically, the substrate 1 is rectangular or square, and the address electrodes 3 extend in parallel to two sides of the substrate 1 and orthogonal to the other sides of the substrate 1. In this specification, the term “orthogonal” or “parallel” means substantially orthogonal or substantially parallel. The detailed shapes of the address electrodes 3 near the end of the substrate 1 are omitted for convenience of illustration and they are shaped so as to be electrically connected to a control circuit substrate at the end of the substrate 1.

The dielectric layer 5 is formed, for example, by applying a glass paste, formed by adding a binder and a solvent to low melting point glass frit, onto the substrate 1 by a screen printing method, and firing the paste. The dielectric layer 5 may also be formed by depositing silicon oxide by a CVD method or the like.

The barrier ribs 7 can be formed by the following method.

### (1) Formation of Barrier Ribs by Etching

In this method, first, a barrier rib material layer is formed on the dielectric layer 5, and barrier ribs 7 are formed by partially removing the barrier rib material layer through etching the barrier rib material layer. A portion to be removed is a neighboring region 9 of two sides 1a, orthogonal to a direction in which the address electrodes 3 extend, of the substrate 1, and a region 11 which becomes a discharge space. In the neighboring region 9, the barrier rib material layer is removed thoroughly and the barrier ribs 7 are not formed. On the two sides 1b, parallel to a direction in which the address electrodes 3 extend, of the substrate 1, the barrier ribs 7 are formed up to the end of the substrate. In another embodiment, the barrier ribs 7 don't have to be formed up to the end of the substrate on one or both of the two sides 1b, parallel to the address electrode 3, of the substrate. The barrier rib material layer can be formed, for example, by applying a glass paste composed of low melting point glass frit, a binder, a solvent, and the like, onto the dielectric layer 5, and drying the glass paste.

Etching can be performed by physical etching or chemical etching. Physical etching is a method for removing an unnecessary portion physically such as by sand blasting. Chemical etching is a method for removing an unnecessary portion by use of chemical or gas which chemically reacts with a layer desired to be removed. Hydrofluoric acid may be used as the chemical for the barrier rib material layer made of glass paste. A portion not to be removed is covered with a resist pattern for protection before etching. The resist pattern can be formed by applying a photoresist or sticking a dry film resist onto the barrier rib material layer, exposing this resist through a photomask and developing this resist.

In another embodiment, as shown in FIG. 2, the barrier ribs 7 may be formed by partially removing the substrate 1 through etching the substrate 1 itself. The address electrodes 3 are formed after the formation of the barrier ribs 7. Thereafter, the dielectric layer 5 may optionally be formed.

### (2) Formation of Barrier Ribs by Use of Laser

In this method, first, a barrier rib material layer is formed on the dielectric layer 5, and barrier ribs 7 are formed by partially removing the barrier rib material layer through irradiating laser light to the barrier rib material layer. An area to be removed and a configuration of the barrier rib material layer are similar to those of etching. Conditions under which laser light is irradiated may be appropriately determined so that the laser light does not create damage to the dielectric layer 5 during removing the barrier rib material layer.

In another embodiment, as shown in FIG. 2, the barrier ribs 7 may be formed by partially removing the substrate 1 through irradiating laser light to the substrate 1 itself. The address electrodes 3 are formed after the formation of the barrier ribs 7. Thereafter, the dielectric layer 5 may optionally be formed.

When the barrier ribs 7 are formed by a method of using laser light, there is no merit of reducing number of photomasks, but there is the merit of omitting the effort to change the setup conditions of the production line of the barrier rib substrate.

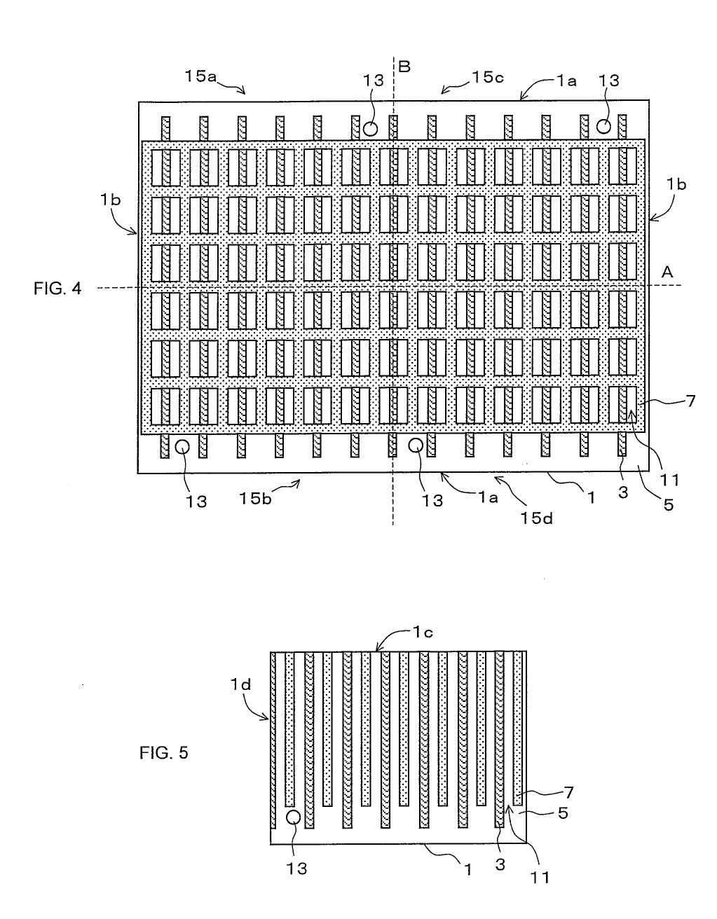

In the first embodiment, the barrier ribs 7 are formed on the dielectric layer 5, but in another embodiment, as shown in FIG. 3, the barrier ribs 7 may be formed on the substrate 1 without providing the dielectric layer 5. In this embodiment, the barrier ribs 7 have a straight form (i.e., are shaped like a stripe), but in another embodiment, as shown in FIG. 4, they may be shaped into a lattice (also referred to as a waffle) or a box. The shapes of the barrier ribs 7 are not particularly limited as long as they can be produced. Characteristics of these embodiments may be appropriately combined.

### 1-1-2. Division Step

Next, by performing division A of the barrier rib substrate for a large PDP in a direction orthogonal to a direction in which the address electrodes 3 extend and at least one-time division B of the barrier rib substrate in a direction parallel to the direction in which the address electrodes 3 extend, four or more barrier rib substrates for small PDPs with barrier ribs formed up to the end formed by the divisions A and B are produced. The divisions A and B are performed, for example, along dotted lines A and B in FIG. 1(a). Division A is usually carried out once, but division B may be carried out two times or more and thereby n sheets (n sheet=2 sheet×(number of divisions B+1)) of barrier rib substrates for small PDPs are produced. The barrier rib substrates for small PDPs produced by the divisions preferably have substantially the same size. A plan view of one of barrier rib substrates for small PDPs obtained by this step is shown in FIG. 5.

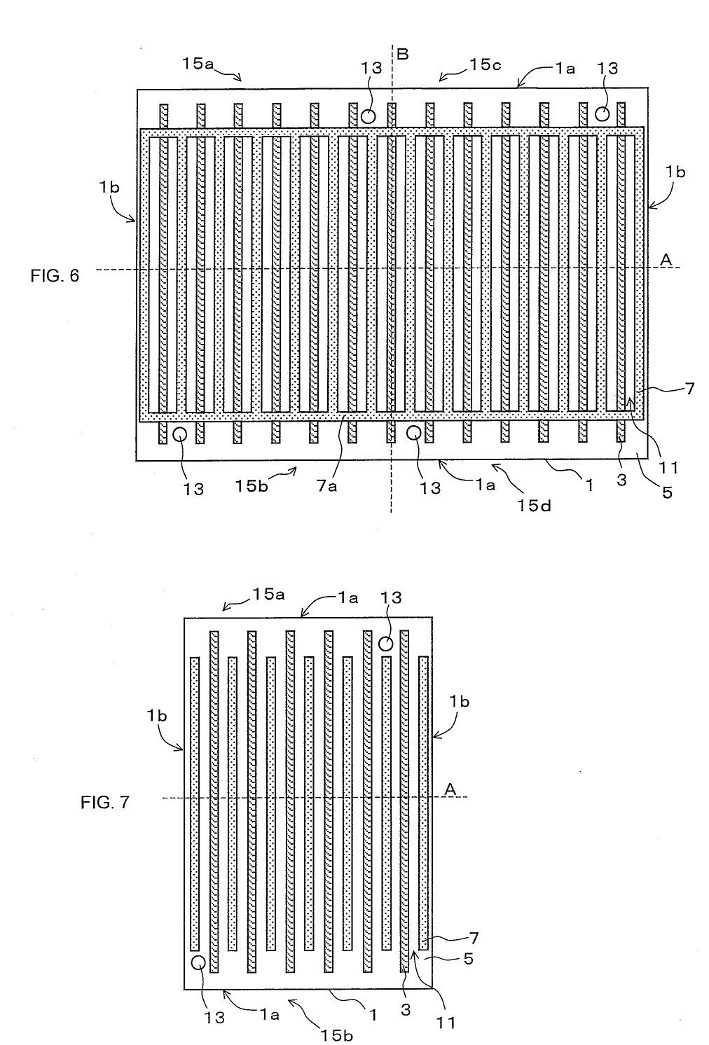

In the method of this embodiment, two adjoining barrier rib substrate units for small PDPs in a direction in which the address electrodes 3 extend in the barrier rib substrate for a large PDP (e.g., a pair of unit 15a and unit 15b, a pair of unit 15c and unit 15d) are located without leaving the space between the units. Further, two adjoining barrier rib substrate units for a small PDP in a direction orthogonal to a direction in which the address electrodes 3 extend in the barrier rib substrate for a large PDP (e.g., a pair of unit 15a and unit 15c, a pair of unit 15b and unit 15d) are located in such a way that a space between two barrier ribs 7 which are closest to a division line (dotted line B) is equal to the pitch of barrier ribs 7. In other words, a plurality of barrier ribs 7 are located in parallel at equal spaces in the barrier rib substrate for a large PDP, and division of the barrier rib substrate for a large PDP is performed at a location between specific two adjacent barrier ribs. Further, when the barrier ribs 7 of the barrier rib substrate for a large PDP have a terminal wall 7a as shown in FIG. 6, this terminal wall 7a is located so as to be common to two adjoining barrier rib substrate units for a small PDP in a direction orthogonal to a direction in which the address electrodes 3 extend in the barrier rib substrate for a large PDP. Since the barrier rib substrates for small PDPs are produced by dividing the barrier rib substrate for a large PDP, both of the barrier rib substrates have barrier ribs identical in the shape and the dimension (pitch, width).

In another embodiment, as shown in FIG. 7, two barrier rib substrates for small PDPs are produced by one-time division. The method of this embodiment comprises the steps of: producing a barrier rib substrate for a large PDP by forming address electrodes 3 extending in a predetermined direction on a substrate and barrier ribs on the substrate or in the substrate itself; and producing two barrier rib substrates for small PDPs with barrier ribs formed up to the end formed by the division A by performing, in regard to the barrier rib substrate for the large PDP, division A in a direction orthogonal to a direction in which the address electrodes 3 extend. The barrier rib substrate units 15a and 15b for small PDPs become two barrier rib substrates for small PDPs by the division. This embodiment is useful for the case where two barrier rib substrates for horizontal PDPs are produced by dividing a barrier rib substrate for a vertical PDP.

### 1-2. Second Embodiment

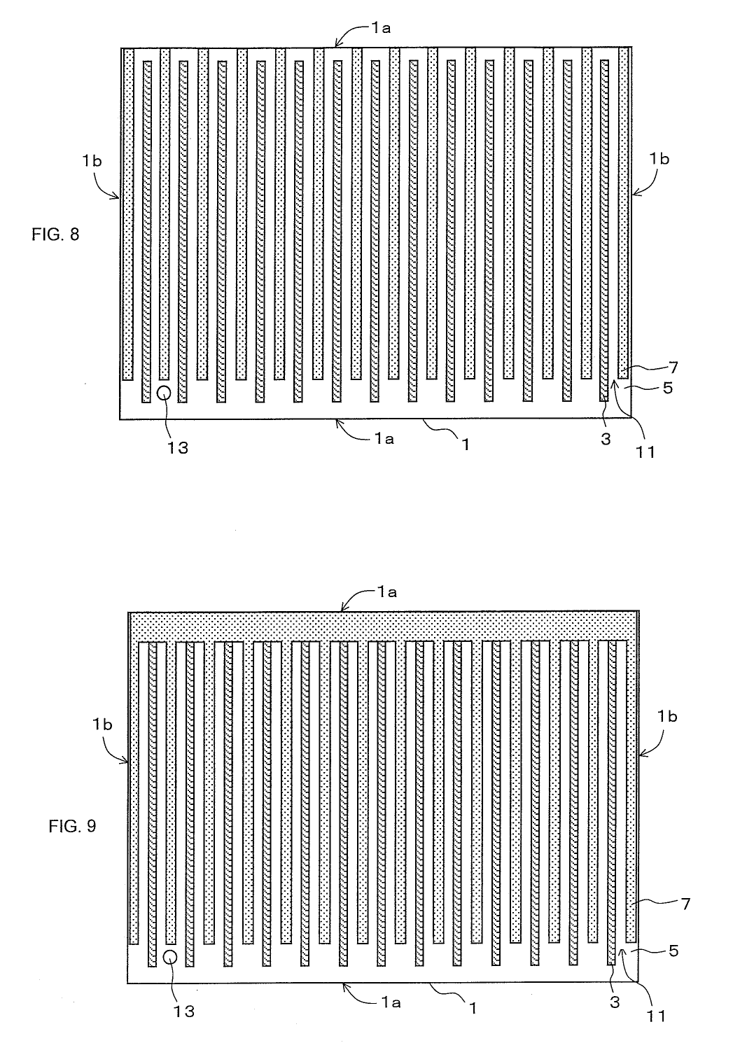

Next, a method for producing a barrier rib substrate for a PDP of the second embodiment of the present invention will be described. This embodiment is a method for producing the barrier rib substrate provided with barrier ribs up to the substrate end produced in the first embodiment easily from a different point of view. This method will be described with reference to FIG. 8

A production method of this embodiment comprises the steps of irradiating laser light to a barrier rib material layer on a substrate 1 or the substrate 1 itself to partially remove the material layer or the substrate in such a way that barrier ribs 7 are formed, and forming address electrodes 3 extending in a predetermined direction on the substrate, wherein the laser irradiation is performed in such a way that the above-mentioned material layer or a portion, having a depth corresponding to a barrier rib height, of the substrate is thoroughly removed in a neighboring region of one side of two sides 1a, orthogonal to a direction in which the address electrodes 3 extend, of the substrate, and the barrier ribs 7 are formed up to the end of the substrate at the other side of two sides 1a. The description of a method of laser irradiating is similar to that in the first embodiment. Conventionally, the material layer or a portion, having a depth corresponding to a barrier rib height, of the substrate is thoroughly removed in neighboring regions of four sides of the substrate 1, but in this embodiment, an amount of processing by laser is less since the barrier ribs 7 are formed up to the substrate end in place of thoroughly removing the material layer or the substrate in at least one side. Accordingly, a processing time can be shortened. At both or one of the two sides 1b, parallel to a direction in which the address electrodes 3 extend, of the substrate, the barrier ribs 7 may be formed up to the substrate end. In addition, in neighboring regions of both of the two sides 1b, the material layer or a portion, having a depth corresponding to a barrier rib height, of the substrate may be thoroughly removed.

It is also possible to reduce an amount of laser processing by not processing the substrate end in place of forming the barrier ribs 7 up to the substrate end. That is, as shown in FIG. 9, this production method comprises the steps of irradiating laser light to a barrier rib material layer formed on a substrate 1 or the substrate 1 itself to partially remove the material layer or the substrate in such a way that barrier ribs 7 are formed, and forming address electrodes 3 extending in a predetermined direction on the substrate, wherein the laser irradiation is performed in such a way that the above-mentioned material layer or a portion, having a depth corresponding to a barrier rib height, of the substrate is thoroughly removed in a neighboring region of one side 1a of two sides, orthogonal to the address electrodes 3, of the substrate, and the top surface of a neighboring region of the other side 1a of the two sides and the top surfaces of the barrier ribs are in the same plane. The barrier rib material layer or the substrate is left intact without being processed at the latter side. The barrier rib substrate can also be produced easily by such a method.

### 2. Method for Producing PDP

Next, a method for producing a three-electrode surface-discharge PDP will be described. A PDP can be produced by sticking the rear-side substrate and the front-side substrate to each other with a sealing material and introducing/encapsulating a discharge gas in a discharge space. Hereinafter, a method for producing a PDP will be described in detail.

(1) Rear-Side Substrate

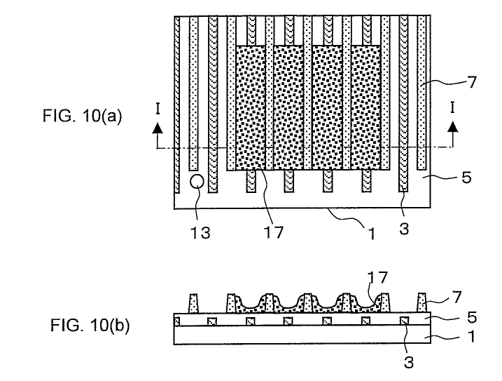

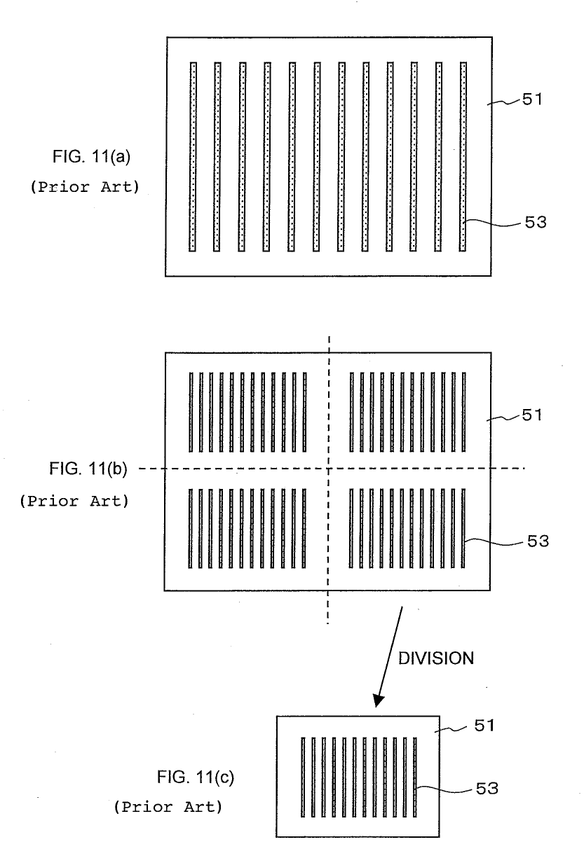

A rear-side substrate can be formed by producing the barrier rib substrate by the above-mentioned method and forming phosphor layers between adjacent barrier ribs 7. As an example, a state in which phosphor layers 17 are formed on the barrier rib substrate shown in FIG. 5 is shown in FIGS. 10(a) and 10(b). FIG. 10(b) is a sectional view taken on a line I-I in FIG. 10(a). In FIGS. 10(a) and 10(b), the phosphor layers 17 are not provided in a region near the periphery of the barrier rib substrate. The reason for this is that this region is to be used for sticking the rear-side substrate to the front substrate. The phosphor layers 17 may be provided for the whole area between barrier ribs 7 unless the phosphor layer interferes with this sticking.

The phosphor layers 17 can be formed by applying a phosphor paste containing phosphor powder and a binder to the inside of a groove between barrier ribs 7 by a screen printing method, a method of using a dispenser, or the like, repeating this application for every color (R, G, B), and firing the paste. The phosphor layers 17 can also be formed by a photolithography method using a phosphor layer material in a sheet form (the so-called green sheet) containing phosphor powder and a binder. In this case, by sticking the sheet of desired color to the whole display area on the substrate, exposing and developing the sheet, and repeating this operation for every color, the phosphor layers of the respective colors can be formed between the corresponding barrier ribs.

### (2) Front-Side Substrate

As the front-side substrate, a substrate on which display electrodes capable of generating surface-discharge are formed can be employed. For example, the front-side substrate described in JP-A No. 2003-5699 can be employed.

### (3) Sticking by Sealing Material

Sticking of the rear-side substrate and the front-side substrate can be performed by applying a sealing material to an area near a peripheral portion of the rear-side substrate, preliminarily firing the sealing material, and firing the front-side substrate and the rear-side substrate with the former overlaid on the latter. Thereby, a space, which communicates with the outside only through an exhaust hole 13, is formed between the rear-side substrate and the front-side substrate. A substance formed by sticking both substrates to each other is referred to as a “panel”. In another embodiment, sticking of the rear-side substrate and the front-side substrate may be performed by applying the sealing material to the front-side substrate, preliminarily firing the sealing material, and firing the front-side substrate and the rear-side substrate with the former overlaid on the latter. In this case, a phenomenon, in which the sealing material is sucked into a space between barrier ribs 7 by a capillary action, becomes less likely to occur. As the sealing material, a glass paste composed of low melting point glass frit, a binder, a solvent, and the like, can be used.

### (4) Exhaust and Introducing/Encapsulating of Discharge Gas

A glass tube is connected to the exhaust hole 13, and the inside of the panel is evacuated through this glass tube under a high-temperature environment and the discharge gas is filled through this glass tube. Thereafter, the glass tube is chipped off and the inside of the panel is sealed to complete the production of the PDP. This step can be performed according to a method described in JP-A No. HEI 7 (1995)-105848. If the barrier rib substrate for a large PDP shown in FIGS. 1(a) and 1(b) is used as-is to produce a large PDP, there are a plurality of exhaust holes 13 in the PDP. In this case, the evacuation can be carried out by use of a plurality of exhaust holes 13. Further, a part of these exhaust holes may be used for preventing the deterioration of characteristics by being connected to a glass tube filled with a getter of impurity gas, instead of being used for evacuation.

### (Others)

The various characteristics described in the above embodiments may be combined. In the case where a plurality of characteristics are included in one embodiment, one or a plurality of these characteristics may be appropriately picked up and employed alone or in combination for the present invention.

1. A method for producing a barrier rib substrate for a plasma display panel comprising the steps of:
producing a barrier rib substrate for a large plasma display panel by forming electrodes extending in a predetermined direction on a substrate and barrier ribs on the substrate or in the substrate itself; and
producing four or more barrier rib substrates for small plasma display panels with barrier ribs formed up to the substrate end by performing, in regard to the barrier rib substrate for the large plasma display panel, the division in a direction orthogonal to a direction in which the electrodes extend and at least one-time division in a direction parallel to the direction in which the electrodes extend.

2. A method for producing a barrier rib substrate for a plasma display panel comprising the steps of:
producing a barrier rib substrate for a large plasma display panel by forming electrodes extending in a predetermined direction on a substrate and barrier ribs on the substrate or in the substrate itself; and
producing two barrier rib substrates for small plasma display panels with barrier ribs formed up to the substrate end by performing, in regard to the barrier rib substrate for the large plasma display panel, the division in a direction orthogonal to a direction in which the electrodes extend.

3. The method of claim 1, wherein the barrier rib substrates for small plasma display panels produced by the division have substantially the same size.

4. A method for producing a barrier rib substrate for a plasma display panel comprising the steps of:
irradiating laser light to a barrier rib material layer on a substrate or the substrate itself to partially remove the material layer or the substrate in such a way that barrier ribs are formed, and
forming electrodes extending in a predetermined direction on the substrate,
wherein the laser irradiation is performed in such a way that the material layer or a portion, having a depth corresponding to a barrier rib height, of the substrate is thoroughly removed in a neighboring region of one side of two sides, orthogonal to a direction in which the electrodes extend, of the substrate, and the barrier ribs are formed up to the substrate end at the other side of the two sides.

5. A method for producing a barrier rib substrate for a plasma display panel comprising the steps of:
irradiating laser light to a barrier rib material layer formed on a substrate or the substrate itself to partially remove the material layer or the substrate in such a way that barrier ribs are formed, and
forming electrodes extending in a predetermined direction on the substrate,
wherein the laser irradiation is performed in such a way that the material layer or a portion, having a depth corresponding to a barrier rib height, of the substrate is thoroughly removed in a neighboring region of one side of two sides, orthogonal to the electrodes, of the substrate, and the top surface of a neighboring region of the other side of the two sides and the top surfaces of the barrier ribs are in the same plane.

6. The method of claim 4, wherein the laser irradiation is performed in such a way that the barrier ribs are formed up to the substrate end at both or one side of two sides, parallel to a direction in which the electrodes extend, of the substrate.

7. A plasma display panel comprising the barrier rib substrate produced by the method of claim 1.

8. A method for producing a plasma display panel comprising the method of claim 1.

9. The method of claim 2, wherein the barrier rib substrates for small plasma display panels produced by the division have substantially the same size.

10. The method of claim 5, wherein the laser irradiation is performed in such a way that the barrier ribs are formed up to the substrate end at both or one side of two sides, parallel to a direction in which the electrodes extend, of the substrate.

11. A plasma display panel comprising the barrier rib substrate produced by the method of claim 2.

12. A plasma display panel comprising the barrier rib substrate produced by the method of claim 4.

13. A plasma display panel comprising the barrier rib substrate produced by the method of claim 5.

14. A method for producing a plasma display panel comprising the method of claim 2.

15. A method for producing a plasma display panel comprising the method of claim 4;

16. A method for producing a plasma display panel comprising the method of claim 5.
